(19) United States
(12) Patent Application Publication
(10) Pub. No.: US 2024/0230477 A1
(43) Pub. Date: Jul. 11, 2024

(54) ADHESIVE FOR COLLECTING HUMAN BODY SAMPLE FROM POROUS SURFACE

(71) Applicant: Republic of Korea(National Forensic Service Director Ministry of Interior and Safety), Wonju-si (KR)

(72) Inventors: Jong Keun Jung, Wonju-si (KR); Min Ho Lee, Wonju-si (KR); Kyoung Sook Kim, Wonju-si (KR); Sang Cheul Shin, Wonju-si (KR); Hyun-Ju Park, Busan (KR); Jae-Hyung Park, Busan (KR)

(21) Appl. No.: 18/405,124

(22) Filed: Jan. 5, 2024

(30) Foreign Application Priority Data
Jan. 5, 2023 (KR) 10-2023-0001600

(51) Int. Cl. G01N 1/04; C09J 175/08

(52) U.S. Cl. CPC G01N 1/04; C09J 175/08

(57) ABSTRACT

Provided is an adhesive for collecting a human body-derived sample from a porous surface of an adherend for DNA type analysis, wherein the adhesive contains a polyurethane aqueous dispersion as a main ingredient.

### CROSS-REFERENCE TO RELATED APPLICATION

This application claims priority to and the benefit of Korean Patent Application No. 2023-0001600, filed on Jan. 5, 2023, the disclosure of which is incorporated herein by reference in its entirety.

### BACKGROUND OF THE DISCLOSURE

### 1. Field of the Disclosure

The present disclosure relates to an adhesive used to collect a sample derived from a human body from a porous surface.

### 2. Description of the Related Art

Among field evidence collected for DNA type analysis, a substance small in volume or cuttable, such as a body hair or clothing may be collected by cutting off an entirety or a portion of the sample. However, evidence fixed to a window frame or a brick or bulky evidence is collected by transferring a human body-derived sample on a surface using tools such as sterile cotton swabs or tape for DNA type analysis on site.

Among the collecting tools, sterilized cotton swabs are easily carried and used, and thus are mainly used when collecting the bulky evidence. In addition, an adhesive tape or M-Vec vacuum equipment is also used for collecting the bulky evidence.

Whether or not the DNA type of the evidence is detected after being transferred to the collecting tool is affected by an amount of the human body-derived sample transferred to the collecting tool. Regarding the evidence that has simply touched the surface, a remaining amount of the human body-derived sample therein is small, so that the DNA type detection rate is low.

Meanwhile, the types of the evidence collected at the scene of an incident are very diverse. A surface from which the evidence is collected may be classified into porous and non-porous surfaces. Human body samples are well deposited on the non-porous surfaces such as glass or plastic, and thus, the DNA type detection rate is high by collecting the same using the sterile cotton swab.

However, regarding the evidence on the porous surface such as a brick or a rock, it is difficult to collect a fingerprint from the porous surface. Thus, an ability to detect the DNA type therefrom may be the only factor in resolving the case. When collecting the human body-derived sample from the porous surface using the sterile cotton swab, retained cells may enter the inside of the brick or the rock or the cotton swab fiber may be damaged, etc. Furthermore, when collecting the human body-derived sample from the porous surface using an adhesive tape, an adhesion strength of the adhesive tape may decrease. When using the vacuum equipment to collect the sample from the porous surface, vacuum inability problems may occur. This problem is required to be removed.

### PRIOR ART LITERATURE

### Non-Patent Literature

(Non-patent Literature 1) C. Hogan et al., Comparison of the quantity and overall quality of trace DNA evidence collected from substrates found at crime scenes, 2018, Journal of Forensic Identification. 2018, 3(341-347)
(Non-patent Literature 2) A. D. Garrett et al., Exploring the potential of a wet-vacuum collection system for DNA recovery, Journal of Forensic Identification, 2014, 5(429-448)
(Non-patent Literature 3) S. Avraham et al., Forensic DNA analysis from rocks and stones in criminal cases, Journal of Forensic Identification, 2015, 65(793-802)

### SUMMARY OF THE DISCLOSURE

Therefore, a purpose of the present disclosure is to provide an adhesive for collecting a human body-derived sample that can collect a large amount of DNA from a porous surface and does not affect DNA degradation.

A first aspect of the present disclosure provides an adhesive for collecting a human body-derived sample from a porous surface of an adherend for DNA type analysis, wherein the adhesive contains a polyurethane aqueous dispersion as a main ingredient thereof.

In accordance with some embodiments, the adhesive further contains 1 to 10% by weight of a silane coupling agent based on 100% by weight of the polyurethane aqueous dispersion.

In accordance with some embodiments, the polyurethane aqueous dispersion comprises 55 to 78% by weight of polyol, 1 to 10% by weight of an ionic group, 20 to 25% by weight of isocyanate, and 1 to 10% by weight of a chain extender.

In accordance with some embodiments, the polyol is a mixture of polytetramethylene glycol (PTMG) and polycarbonate diol (PCD), wherein a molar ratio of polytetramethylene glycol (PTMG) and polycarbonate diol (PCD) in the mixture is in a range of 0.5 to 1.5.

In accordance with some embodiments, the polyurethane aqueous dispersion is prepared by: adding and mixing the polyol, the ionic group, and a catalyst to and with a solvent to produce a mixed solution, and then adding the isocyanate to the mixed solution to prepare a pre-polymer; adding a neutralizing agent to the pre-polymer for water dispersion; and adding water thereto to produce an aqueous dispersion, and then adding the chain extender thereto to extend a chain, thereby preparing the polyurethane aqueous dispersion.

In accordance with some embodiments, a NCO/OH ratio of the pre-polymer is in a range of 1.05 to 2.5.

A second aspect of the present disclosure provides a human body-derived sample collecting method comprising: applying the adhesive as described above onto a porous surface; drying the adhesive; and peeling off the dried adhesive from the porous surface to collect the human body-derived sample.

When collecting the human body-derived sample from the porous surface using the urethane-based adhesive according to an embodiment of the present disclosure, a large amount of DNA may be collected from the porous surface. The hydrophilic urethane-based adhesive has excellent wettability with or adhesion to blood.

Furthermore, a chemical ingredient included in the urethane-based adhesive according to an embodiment of the present disclosure do not affect DNA degradation.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a flowchart of a method for preparing polyurethane aqueous dispersion according to an embodiment of the present disclosure;

FIG. 2 is a photograph showing a porous surface according to an embodiment of the present disclosure;

FIG. 3 is a photograph showing a state in which an adhesive prepared according to an embodiment of the present disclosure is applied onto a porous surface and then dried;

FIG. 4 is a diagram to illustrate a method of collecting a human body-derived sample from a porous surface according to Comparative Example of the present disclosure; and

FIG. 5 is a graph showing results of FT-IR spectrum measurement analyzing chemical properties of an adhesive according to Present Example of the present disclosure, and a rubber coating agent according to Comparative Example of the present disclosure.

### DETAILED DESCRIPTION OF THE DISCLOSURE

The present disclosure will be described in detail below through preferred embodiments. Prior to this description, the terms or words used in the present specification and claims should not be construed as limited to their usual or dictionary meanings, and should be interpreted as meaning and concept consistent with the technical idea of the present disclosure based on the principle that the inventor may appropriately define the concept of terms in order to explain his or her invention in the best way. Therefore, it should be understood that the configuration of the embodiments as described in the present specification is only one of the most preferred embodiments of the present disclosure and does not represent all of the technical ideas of the present disclosure, and therefore, various equivalents and modifications that may replace them at the time of filing the present application are available. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof.

The adhesive for collecting the human body-derived sample according to an embodiment of the present disclosure refers to an adhesive for collecting the human body-derived sample from the porous surface. In this regard, the porous surface may be an adherend surface with many pores formed therein, such as a surface of the brick or the rock.

The adhesive according to an embodiment of the present disclosure contains polyurethane aqueous dispersion as a main ingredient. The polyurethane aqueous dispersion may be a resin that serves as a base of an adhesive composition for collecting the human body-derived sample from the porous surface.

Specifically, the polyurethane aqueous dispersion may be composed of 55 to 78% by weight of polyol, 1 to 10% by weight of an ionic group, 20 to 25% by weight of isocyanate, and 1 to 10% by weight of a chain extender. Preferably, the polyurethane aqueous dispersion may be composed of 65 to 70% by weight of polyol, 3 to 7% by weight of the ionic group, 20 to 25% by weight of isocyanate, and 2 to 8% by weight of the chain extender.

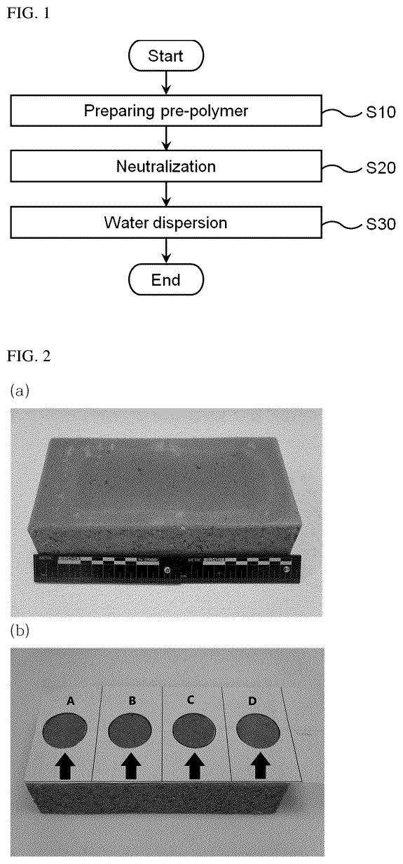

FIG. 1 is a step-by-step flowchart of a method for preparing the polyurethane aqueous dispersion according to an embodiment of the present disclosure.

As shown in FIG. 1, the method for preparing the polyurethane aqueous dispersion according to an embodiment of the present disclosure may include a step of preparing a polyurethane pre-polymer in S10, a neutralization step in S20, and a water dispersion step in S30.

First, in the step of preparing the polyurethane pre-polymer in S10, in order to synthesize the water-dispersed polyurethane resin, a catalyst may be added and mixed with polyol, the ionic group, and a solvent to prepare a mixture and then isocyanate may be added thereto to prepare the pre-polymer.

The polyol is an organic compound containing at least two hydroxyl groups, and may improve the cohesion of the adhesive. The polyurethane aqueous dispersion according to an embodiment of the present disclosure preferably contains 55 to 78% by weight of the polyol, more preferably, 65 to 70% by weight thereof. If the content of the polyol is outside the lower limit of the above range, the cohesion of the adhesive may be reduced, and if the content is outside the upper limit of the above range, the hydrolysis resistance may be reduced.

The polyol according to an embodiment of the present disclosure may be any one or a combination of polytetramethylene glycol (PTMG), polycarbonate diol (PCD), and perfluoropolyether (PFPE). The polyol according to a preferred embodiment is preferably a mixture of polytetramethylene glycol (PTMG) and polycarbonate diol (PCD). In this regard, a mixed molar ratio of polytetramethylene glycol (PTMG) and polycarbonate diol (PCD) may be 0.5 to 1.5, preferably 1.

Furthermore, the ionic group is added for improving the hydrolysis resistance and may be either dimethylolpropionic acid (DMPA) or dimethylolbutanoic acid (DMBA) or a combination thereof. The polyurethane aqueous dispersion may include 1 to 10% by weight of the ionic group, preferably 3 to 7% by weight thereof. If the content of the ionic group is outside the lower limit of the above range, problems may occur where emulsification and water dispersion stability may be reduced, while if the content of the ionic group is outside the upper limit of the above range, the hydrolysis resistance may be reduced.

The polyol, the ionic group, and the catalyst may be added to the solvent and may be mixed with each other to produce the mixture, and then the isocyanate may be added thereto to prepare the polyurethane pre-polymer in S10). In this regard, the solvent may be any one or a combination of methyl ethyl ketone (MEK), dimethylformamide (DMF), and toluene, and the catalyst added thereto may be DBTDL (dibutyltin dilaurate), etc.

Furthermore, the isocyanate is used to prepare the polyurethane pre-polymer having an isocyanate group at each of both opposing ends of a molecule via reaction. The isocyanate may be any one of isophorone diisocyanate (IPDI), 4,4′-methylenebiscyclohexane diisocyanate (4-4′-H12MDI), 1,6-hexamethylene diisocyanate (1,6-HDI), 1,3-xylene diisocyanate (1,3-XDI), and 1,3-tetramethylxylene diisocyanate (1,3-TMXDI), or a combination thereof. The polyurethane aqueous dispersion according to one embodiment of the present disclosure preferably contains 20 to 25% by weight of the isocyanate.

In this regard, in the synthesis of the polyurethane pre-polymer, a NCO/OH ratio of the polyol compound and the isocyanate compound may be in a range of 1.05 to 2.5, preferably 1.25 to 2.0. If the ratio is outside the above range, the polyurethane pre-polymer may not be prepared properly due to poor performance in terms of viscosity or ease of defoaming.

Afterwards, the prepared polyurethane pre-polymer may be neutralized in S20 by adding a neutralizing agent thereto such that the water dispersion is possible.

In this regard, the neutralizing agent is a basic compound. When the neutralizing agent is added thereto, the polyurethane pre-polymer is chemically neutralized to produce a salt, thereby imparting water dispersion properties. In this regard, the neutralizing agent may be any one or a combination of triethylamine (TEA), triethanolamine (TEA), dimethylcyclohexylamine, ethyldiisopropylamine, dimethylaminoethanol, and N-methylmorpholine.

Furthermore, in this regard, the polyurethane pre-polymer may be dissolved in a low boiling point solvent to achieve a viscosity suitable for the water dispersion. The low boiling point solvent may be any one of acetone, methyl ethyl ketone, cyclohexanone, methyl isobutyl ketone, N, N-dimethylformamide, and N,N-dimethylacetamide, or a combination thereof.

Next, after the neutralization in S20, water may be added thereto, followed by stirring such that water dispersion may be achieved, and then, the chain extender may be added thereto to extend the chain in S30. In this way, the polyurethane aqueous dispersion may be prepared.

In this regard, the chain extender may be a diamine-based chain extender, and may be any one of EDA (Ethylene diamine), IPDA (Isophorone diamine), piperazine, hydrazine, and HMDA (hexamethylenediamine), or a combination thereof.

Thereafter, although not shown in the drawing, a step of removing the low boiling point solvent used to adjust the viscosity using a reduced pressure distillation method or the like may be further included.

Based on 100% by weight of the polyurethane aqueous dispersion prepared in this way, 1 to 10% by weight, preferably 3 to 7% by weight, of a silane coupling agent may be added thereto.

In this regard, the silane coupling agent may include one of vinyl silanes (vinyl trichloro silane, vinyl trimethoxy silane, vinyl triethoxy silane), epoxy silanes (γ-glycidoxypropylmethyldiepoxy silane, γ-glycidoxysilane) Doxypropyltrimethoxy silane, γ-glycidoxypropyltriethoxy silane), amino silanes (γ-aminopropyltrimethoxy silane, γ-aminopropyltriethoxy silane), methacryloxy silanes (γ-methacryloxypropyltriethoxy silane, γ-methacryloxypropyltrimethoxy silane), chloropropyl silane (γ-chloropropyltriethoxy silane), mercapto silane (γ-mercaptopropyltrimethoxy silane), or a combination thereof.

When the content of the silane coupling agent added to polyurethane aqueous dispersion is outside the above range, there is a problem in that efficiency in terms of adhesion and workability is reduced.

Hereinafter, the present disclosure will be described in more detail through preparing examples of the present disclosure, but the scope of the present disclosure is not limited by the preparing examples as presented below.

### Preparing Example of Polyurethane Aqueous Dispersion

A temperature gauge, a reflux condenser, a nitrogen inlet, and a stirrer were installed in a 5-neck reactor with a capacity of 1 L. Polyol was obtained by mixing moisture-removed polytetramethylene glycol (PTMG) and polycarbonate diol (PCD) with each other in a 1:1 molar ratio. 68% by weight of the prepared polyol was placed into the reactor, 5% by weight of dimethylol propionic acid (DMPA) was added thereto, followed by stirring for uniform mixing. Afterwards, 22% by weight of isophorone diisocyanate (IPDI) was added thereto dropwise at 80° C. for 1 hour and 30 minutes to synthesize the pre-polymer. Afterwards, the temperature was lowered to 65° C., and then, 5% by weight of triethylamine (TEA) was added thereto, followed by stirring for 30 minutes. Then, the temperature of the reactant was cooled to below 40° C., and then 750% by weight of water based on 100% by weight of the polyol was slowly added thereto, followed by stirring to achieve the water dispersion thereof. After water dispersion was completed, 5% by weight of ethylenediamine (EDA) was dissolved in water to produce a solution, and then, the solution was added dropwise to the water dispersion product over 1 hour. Then, disappearance of a NCO peak was confirmed using FT-IR spectrum. In this way, a final polyurethane aqueous dispersion was obtained.

The adhesive for collecting the human body-derived sample containing the polyurethane aqueous dispersion as prepared according to the example of the present disclosure as a main ingredient may be applied to the porous surface in a non-limiting manner, dried, and then peeled away therefrom, thereby collecting the human body-derived sample therefrom.

For example, the adhesive may be poured onto, applied with a brush, or sprayed onto the porous surface so as to have a predetermined thickness (e.g., 2 mm to 5 mm). However, the present disclosure does not specifically limit the application scheme of the adhesive.

### Present Example 1

The porous surface was prepared by immersing a red brick (Sunil Industry, Korea, 230 mm×114 mm×60 mm) as shown in (a) in FIG. 2 in 5% sodium hypochlorite solution for 30 minutes, washing the brick twice with sterile water and drying the brick on a sterile laboratory bench for 3 days.

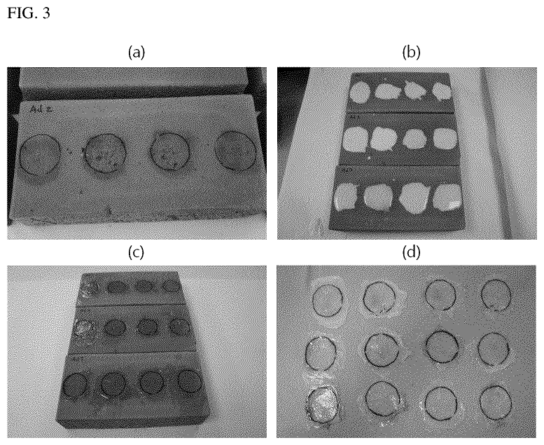

Blood was collected from a voluntary volunteer and was used as the human body-derived sample. Collection and use of the sample were conducted after deliberation and approval by the National Institute of Forensic Science's Institutional Bioethics Committee. (906-220524-BR-001-01). After whole blood collection, the blood was stored in a 5 ml storage container containing ethylenediaminetetraacetic acid (EDTA), diluted 10 times with physiological saline, and used as the human body-derived sample. 100 μ [symbol] of the human body-derived sample was applied, using a disposable sprayer, onto four oval areas with a diameter of 4 cm (see (b) in FIG. 2, A to D) of the dried red brick and was dried for 24 hours. (See (a) in FIG. 3).

Further, the polyurethane aqueous dispersion prepared according to the above preparing example was poured on the oval area of the brick so as to have a thickness of 3 mm (see (b) in FIG. 3), and was dried for 12 hours (see (c) in FIG. 3). Then, a top portion of the adhesive was removed with tweezers and thus the sample was collected from the porous surface (see (d) in FIG. 3).

### Comparative Example 1

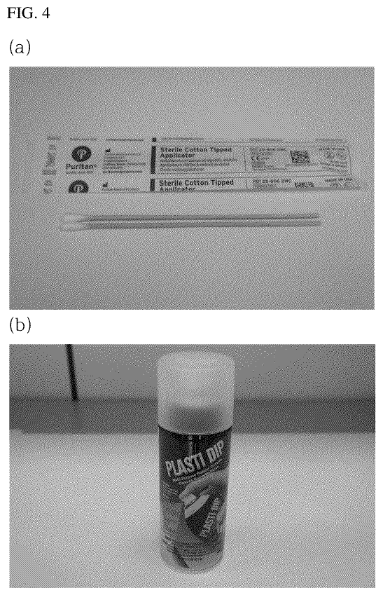

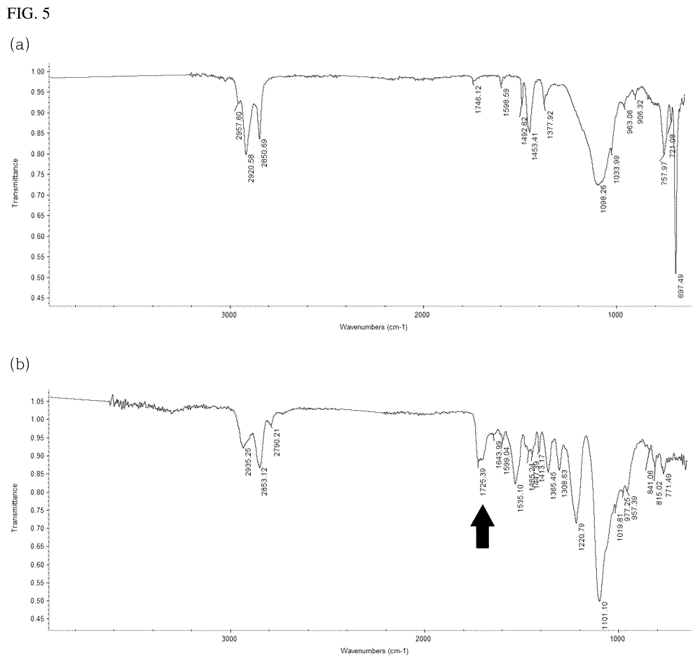

The test was conducted in the same manner as Present Example 1 except that a sterile cotton swab was used instead of polyurethane aqueous dispersion to collect the human body-derived sample from the porous surface (see (a) in FIG. 4).

In this regard, the fiber of the sterilized cotton swab was soaked with saline solution, and then, the four oval areas (A to D) of the porous surface of the red brick were wiped with the cotton swab for 3 minutes, and then the fiber was cut therefrom with a medical knife. Thus, the sample was collected from the porous surface.

### Comparative Example 2

The test was conducted in the same manner as Present Example 1 except that a rubber coating agent was used instead of the polyurethane aqueous dispersion to collect the human body-derived sample from the porous surface (see (b) in FIG. 4).

In this regard, the rubber coating agent was Plasti Dip® from Plasti Dip International (specifications: Plasti Dip International, Plasti Dip Technical Data Sheet Minnesota, 2002, https://www.plastidip.net.au/technical-data-sheets). The rubber coating agent was sprayed from a position about 30 cm above the red brick with the porous surface onto an entirety of the porous surface for 5 seconds, and then was dried for 15 minutes. The spraying and drying process was repeated five times.

After the last spraying was completed, the rubber coating agent was dried for 12 hours, and then, the rubber coating was removed therefrom, and the oval area thereof was cut with scissors. Thus, the sample was collected from the porous surface.

### Experimental Example 1

The sample collected according to each of Present Example 1 and Comparative Examples 1 to 2 was added to a microtube in which 300 μ [symbol] of PrepFiler Lysis Buffer (Applied biosystems Life technology, USA) was contained, and reacted in a thermostat at 72 C for 40 minutes, and then, an experiment was performed using Nimbus presto (HAMILTON, USA) according to the user manual, and a final 80 μ [symbol] (was purified. The extracted DNA was quantified using the Quantifiler TRIO Quantification Kit (Applied Biosystems Life technology, USA), and 2 μ [symbol] of DNA was reacted according to the user manual. Then, quantification and degradation index thereof were identified using the 7500 Real-Time PCR system (Applied Biosystems Life technology, USA). DNA amplification was performed by carrying out PCR (polymerase chain reaction) on lye of the extracted DNA using the GlobalFiler PCR Amplification Kit (Applied Biosystems Life technology, USA) with the ProFlex PCR system (Applied Biosystems Life technology, USA) according to the user's manual. The DNA type analysis was performed by carrying out capillary electrophoresis on 1μ [symbol] of enzyme polymerization chain reaction product using Genetic Analyzer ABI 3500x1 (Applied Biosystems Life technology, USA). Afterwards, analysis was performed using GeneMapper IDX software (ver 1.4), and the RFU (Relative Fluorescent Unit) value of the locus was analyzed with a minimum standard of 50.

The LMG (Leuco malachite Green) test method was used to check the remaining amount of the human body-derived sample after the collection thereof.

As a result, when analyzing the average amount of DNA as collected according to the collecting tool, as shown in Table 1 below, the sterilized cotton swab was used to collect 0.0423 ng/μl. The rubber coating agent was used to collect 0.6434 ng/μl. The urethane-based adhesive (the polyurethane aqueous dispersion according to Present Example 1) (hereinafter, the polyurethane aqueous dispersion according to Present Example 1) was used to collect 0.9343 ng/μ [symbol] as the highest amount of DNA. The average DNA quantitative value of the diluted blood was 1.36 ng/μ [symbol] . A collection percentage was calculated by dividing the average DNA quantitative value measured based on each collecting tool by the 1.36 ng/μ [symbol] . The collection percentage was as follows: 68.6% when using the urethane adhesive, 47.2% when using the rubber coating agent, and 2.9% when using the sterilized cotton swab. In a similar study, 20,000 oral saliva cells were deposited on the bricks and the sterile cotton swabs, the rayon swabs, the rubber coating agent were used to collect the sample. The collection results were as follows: DNA quantitative values of 0.003 to 0.038 ng/μ [symbol] when using the sterile cotton swabs and rayon swabs, and 0.28 ng/μ [symbol] when using the rubber coating agent.

TABLE 1

| | | | | | | | | Collection |
|---|---|---|---|---|---|---|---|---|
| | Sample | Detection concentration(ng/μ [symbol] ) | | | | Average | Standard | percentage |
| | number | A | B | C | D | (ng/μ [symbol] ) | Deviation | (%) |
| Sterile | 1 | 0.0582 | 0.0674 | 0.0484 | 0.0243 | 0.0423 | 0.0236 | 2.9 |
| cotton | 2 | 0.0309 | 0.0129 | 0.0187 | 0.0201 | | | |
| swab | 3 | 0.0836 | 0.0732 | 0.0415 | 0.0278 | | | |
| Rubber | 1 | 0.3180 | 0.3408 | 0.7005 | 0.6705 | 0.6434 | 0.2674 | 47.2 |
| coating | 2 | 0.9803 | 1.0713 | 0.8273 | 0.5562 | | | |
| agent | 3 | 0.3349 | 0.3825 | 0.6077 | 0.9310 | | | |
| Urethane | 1 | 0.4623 | 0.5783 | 1.0221 | 0.7886 | 0.9343 | 0.2504 | 68.6 |
| adhesive | 2 | 0.9702 | 1.1404 | 0.9673 | 0.8347 | | | |
| | 3 | 1.4033 | 0.9574 | 0.9661 | 1.1216 | | | |

### Experimental Example 2

The DNA degradation index was checked to determine the effect of the chemical component included in the collecting tool on the human body-derived sample. The lower the DNA degradation index value, the more stable the DNA. The average value of the DNA degradation index based on each collecting tool was as follows: 0.57 when using the sterilized cotton swab, 0.48 when using the rubber coating agent, and 0.48 when using the urethane-based adhesive (see Table 2 below). each of the rubber coating agent and the urethane-based adhesive containing the chemical ingredients had the degradation index lower than that of the sterilized cotton swab. Thus, it could be determined that the chemical ingredient included in the collecting tool did not have the effect on the sample.

TABLE 2

| | Sample | DNA degradation index | | | | | Standard |
|---|---|---|---|---|---|---|---|
| | number | A | B | C | D | Average | Deviation |
| Sterile | 1 | 0.73 | 0.47 | 0.96 | 0.37 | 0.57 | 0.16 |
| cotton | 2 | 0.46 | 0.63 | 0.69 | 0.61 | | |
| swab | 3 | 0.41 | 0.45 | 0.58 | 0.49 | | |
| Rubber | 1 | 0.43 | 0.45 | 0.50 | 0.52 | 0.48 | 0.04 |
| coating | 2 | 0.47 | 0.55 | 0.51 | 0.41 | | |
| agent | 3 | 0.53 | 0.47 | 0.48 | 0.48 | | |
| Urethane | 1 | 0.49 | 0.42 | 0.46 | 0.51 | 0.48 | 0.05 |
| adhesive | 2 | 0.49 | 0.52 | 0.47 | 0.36 | | |
| | 3 | 0.52 | 0.51 | 0.56 | 0.50 | | |

### Experimental Example 3

Based on a result of analyzing the number of detected loci of DNA types based on the collecting tool, the DNA type was detected in all samples when using each of the rubber coating and the urethane-based adhesive (see Table 3 below). When suing the sterile cotton swab, all of DNA types were detected in only two samples, and only some of DNA types were detected in the remaining samples.

TABLE 3

| | | Number of detected loci/Total number of loci | | | |
|---|---|---|---|---|---|
| | Sample | (Detection percentage, %) | | | |
| | number | A | B | C | D |
| Sterile | 1 | 21/42(50) | 36/42(86) | 19/42(45) | 22/42(52) |
| cotton | 2 | 40/42(95) | 35/42(83) | 34/42(81) | 36/42(86) |
| swab | 3 | 35/42(83) | 42/42(100) | 42/42(100) | 41/42(98) |
| Rubber | 1 | 42/42(100) | 42/42(100) | 42/42(100) | 42/42(100) |
| coating | 2 | 42/42(100) | 42/42(100) | 42/42(100) | 42/42(100) |
| agent | 3 | 42/42(100) | 42/42(100) | 42/42(100) | 42/42(100) |
| Urethane | 1 | 42/42(100) | 42/42(100) | 42/42(100) | 42/42(100) |
| adhesive | 2 | 42/42(100) | 42/42(100) | 42/42(100) | 42/42(100) |
| | 3 | 42/42(100) | 42/42(100) | 42/42(100) | 42/42(100) |

### Experimental Example 4

FT-IR spectrum was measured to analyze the chemical characteristics of the rubber coating agent (see (a) in FIG. 5) and the urethane-based adhesive (see in (b) in FIG. 5) among the collecting tools. Based on a result of checking the peak around 1725 cm⁻¹ which represents the C═O group, the urethane-based adhesive (hydrophilic) exhibited a higher value compared to that of the rubber coating agent (oleophilic). This suggests that urethane-based adhesive has better adhesion to the human body-derived sample (blood) which has water-soluble properties. Based on a result of checking a contact angle of a surface film made of each of the rubber coating agent and the urethane-based adhesive with respect to the water-soluble substance, the contact angle of the rubber coating was 71.4 degrees and that of the urethane-based adhesive was 36.7 degrees. Thus, it was determined that the urethane-based adhesive had excellent wettability with blood as the water-soluble substance.

The preferred embodiment of the present disclosure has been described above in detail with reference to the drawings. The description of the present disclosure is for illustrative purposes, and a person with ordinary knowledge in the technical field to which the present disclosure belongs may understand that the present disclosure may be easily modified into another specific form without changing the technical idea or essential features of the present disclosure.

Therefore, the scope of the present disclosure is indicated by the claims described later rather than the detailed description above, and all changes or modified forms derived from the meaning, scope, and concept of equivalents of the claims should be interpreted as being included in the scope of the present disclosure.

1. An adhesive for collecting a human body-derived sample from a porous surface of an adherend for DNA type analysis, wherein the adhesive contains a polyurethane aqueous dispersion as a main ingredient thereof.

2. The adhesive for collecting the human body-derived sample of claim 1, wherein the adhesive further contains 1 to 10% by weight of a silane coupling agent based on 100% by weight of the polyurethane aqueous dispersion.

3. The adhesive for collecting the human body-derived sample of claim 1, wherein the polyurethane aqueous dispersion comprises 55 to 78% by weight of polyol, 1 to 10% by weight of an ionic group, 20 to 25% by weight of isocyanate, and 1 to 10% by weight of a chain extender.

4. The adhesive for collecting the human body-derived sample of claim 3, wherein the polyol is a mixture of polytetramethylene glycol (PTMG) and polycarbonate diol (PCD),
wherein a molar ratio of polytetramethylene glycol (PTMG) and polycarbonate diol (PCD) in the mixture is in a range of 0.5 to 1.5.

5. The adhesive for collecting the human body-derived sample of claim 3, wherein the polyurethane aqueous dispersion is prepared by:
adding and mixing the polyol, the ionic group, and a catalyst to and with a solvent to produce a mixed solution, and then adding the isocyanate to the mixed solution to prepare a pre-polymer;
adding a neutralizing agent to the pre-polymer for water dispersion; and
adding water thereto to produce an aqueous dispersion, and then adding the chain extender thereto to extend a chain, thereby preparing the polyurethane aqueous dispersion.

6. The adhesive for collecting the human body-derived sample of claim 5, wherein a NCO/OH ratio of the pre-polymer is in a range of 1.05 to 2.5.

7. A human body-derived sample collecting method comprising:
applying the adhesive according to claim 1 onto a porous surface;
drying the adhesive; and
peeling off the dried adhesive from the porous surface to collect the human body-derived sample.

8. The human body-derived sample collecting method of claim 7, wherein the adhesive further contains 1 to 10% by weight of a silane coupling agent based on 100% by weight of the polyurethane aqueous dispersion.

9. The human body-derived sample collecting method of claim 7, wherein the polyurethane aqueous dispersion comprises 55 to 78% by weight of polyol, 1 to 10% by weight of an ionic group, 20 to 25% by weight of isocyanate, and 1 to 10% by weight of a chain extender.

10. The human body-derived sample collecting method of claim 9, wherein the polyol is a mixture of polytetramethylene glycol (PTMG) and polycarbonate diol (PCD),
wherein a molar ratio of polytetramethylene glycol (PTMG) and polycarbonate diol (PCD) in the mixture is in a range of 0.5 to 1.5.

11. The human body-derived sample collecting method of claim 9, wherein the polyurethane aqueous dispersion is prepared by:
adding and mixing the polyol, the ionic group, and a catalyst to and with a solvent to produce a mixed solution, and then adding the isocyanate to the mixed solution to prepare a pre-polymer;
adding a neutralizing agent to the pre-polymer for water dispersion; and
adding water thereto to produce an aqueous dispersion, and then adding the chain extender thereto to extend a chain, thereby preparing the polyurethane aqueous dispersion.

12. The human body-derived sample collecting method of claim 11, wherein a NCO/OH ratio of the pre-polymer is in a range of 1.05 to 2.5.
